(19) United States
(12) Patent Application Publication
(10) Pub. No.: US 2009/0154140 A1
(43) Pub. Date: Jun. 18, 2009

(54) ILLUMINATING APPARATUS FOR DISPLAYING APPARATUS AND DISPLAYING APPARATUS

(75) Inventors: Kentaroh Aoki, Tokyo (JP); Motoaki Okitsu, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 11/719,612

(22) PCT Filed: Aug. 10, 2005
(86) PCT No.: PCT/JP2005/014667

§ 371 Date: May 17, 2007

(30) Foreign Application Priority Data
Nov. 30, 2004 (JP) 2004-347326

(51) Int. Cl. G02F 1/13357; F21V 1/00

(52) U.S. Cl. 362/97.2; 362/235; 362/97.1

(57) ABSTRACT

An illuminating apparatus for a displaying apparatus has a clearance C provided between an end edge of a reflective sheet and a base part of a rubber holder which is located on the outer edge of the reflective sheet and closely fixed to the bottom plate part. In addition, the clearance C is set between the hole edge of the mounting hole and the supporting base part of the lamp clip, around the mounting hole. Therefore, expansion deformation of the reflective sheet in the sheet surface direction due to thermal expansion and variation of dimensions due to mold tolerance can be absorbed by the clearances C. As a result, deflection and curling of the reflective sheet is reliably prevented.

### BACKGROUND OF THE INVENTION

1. Field of the Invention

The present invention relates to an illuminating apparatus for a displaying apparatus, and a displaying apparatus.

2. Description of the Related Art

In a non-light emitting displaying apparatus such as a liquid crystal display, a backlight unit for illumination is provided on a back surface of a panel (see Japanese Patent Laid-Open No. 6-95110, for example). The backlight unit is composed of a large number of light sources such as cold cathode tubes arranged side by side in a case made of metal formed in a shallow dish-like shape. These light sources are fixed on a bottom surface of the case by means of holding elements such as clips or holders.

Within the case, a reflective sheet made of resin may be disposed in order to reflect and supply light from the light sources to the panel. The reflective sheet is fixed on the bottom surface of the case by putting the sheet between the holding elements which fix the light sources and the bottom surface of the case.

However, during operation of the displaying apparatus, the temperature in the case is high due to heat from the light sources. Therefore, the temperature in the case significantly varies with repetition of operation/stop of the apparatus. With this temperature change, the case and the reflective sheet expand and contract. Because the thermal expansion coefficient of the reflective sheet made of resin is larger than that of the case made of metal, the case can not follow expansion/contraction of the reflective sheet, which can result in deflection of the reflective sheet around the holding elements and curling of end parts of the sheet away from the holding elements.

In addition, if misalignment with respect to the fixing positions with the holding elements occurs due to dimensional tolerances in manufacturing the reflective sheet, deflection and curling of the reflective sheet can occur.

### SUMMARY OF THE INVENTION

In order to overcome the above described problems, preferred embodiments of the present invention provide an illuminating apparatus for a displaying apparatus and a displaying apparatus which can prevent deflection and curling of the reflective member.

An illuminating apparatus for a displaying apparatus according to a preferred embodiment of the present invention includes light sources; a case part arranged to receive the light sources; a reflective member arranged to reflect light from the light sources, the reflective member being disposed on a wall surface of the case part; and light source holding elements arranged to hold the light sources and the reflective member, the light source holding elements being attached to the wall surface of the case part, wherein each of the light source holding elements includes a close fixing part closely contacting the wall surface of the case part; a cover part extending around the close fixing part along the wall surface but spaced from the wall surface, the cover part projecting above the reflective member; and light source holding parts being capable of holding the light sources, the light source holding parts being provided in the close fixing part or the cover part, and a clearance is provided between an edge of the reflective member and the close fixing part to allow misalignment of the reflective member in a surface direction.

In preferred embodiments of the present invention, the term “edge” of the reflective member means not only end edges (outer circumferential edges) of the reflective member, but also hole edges of holes or inner circumferential edges of slits or the like, if holes or slits or the like for attaching the light source holding elements are provided in the reflective member.

According to preferred embodiments of the present invention, deflection and curling of the reflective member can be prevented because expansion deformation in the surface direction due to heat expansion and variation of dimensions due to mold tolerance can be absorbed.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an exploded perspective view of a liquid crystal display.

FIG. 2 is a side cross sectional view of the liquid crystal display.

FIG. 3 is a partial enlarged view of a backlight unit.

FIG. 4 is a perspective view of a rubber holder.

FIG. 5(A) is a view of the rubber holder seen from an inner side of a case and FIG. 5(B) is a side cross sectional view of the rubber holder.

FIG. 6 is a side cross sectional view of the rubber holder and a lamp holder before attachment to the case.

FIG. 7 is a side cross sectional view of the rubber holder and a lamp holder after attachment to the case.

FIG. 8(A) is a side view of a lamp clip and FIG. 8(B) is a rear view of the lamp clip.

FIG. 9 is a side cross sectional view of the lamp clip before attachment to the case.

FIG. 10 is a side cross sectional view of the lamp clip after attachment to the case.

### DETAILED DESCRIPTION OF PREFERRED EMBODIMENTS

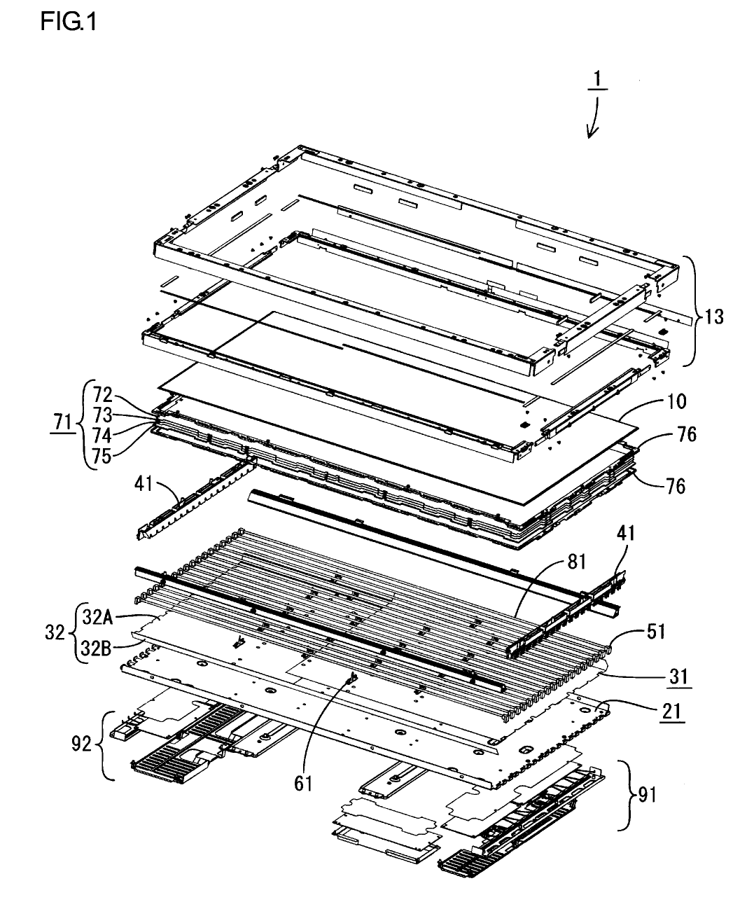

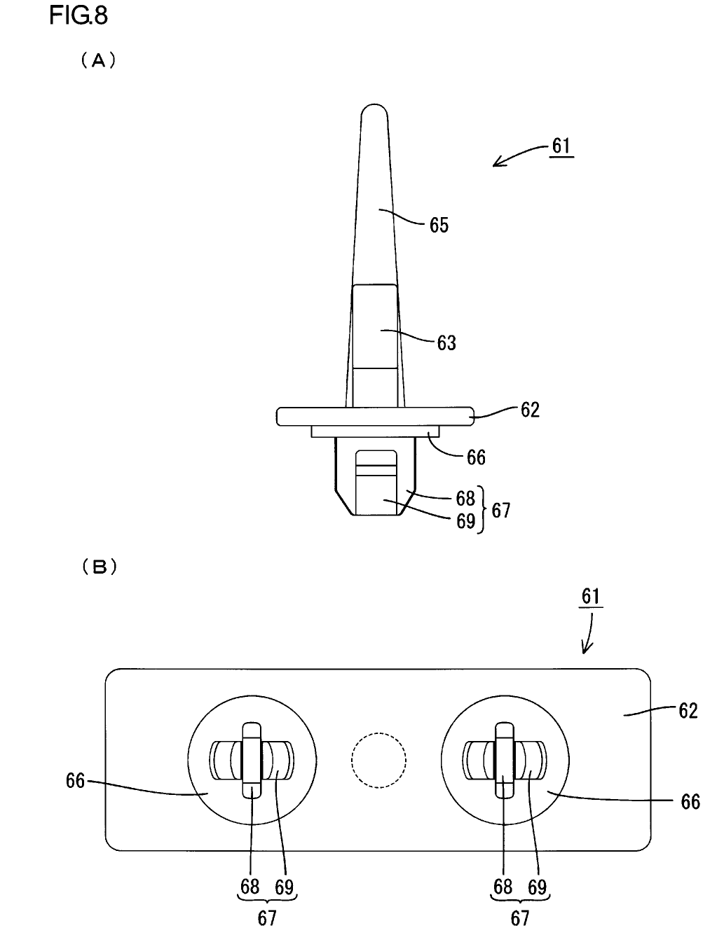

Now, preferred embodiments of the present invention will be described in detail with reference to FIGS. 1 to 10.

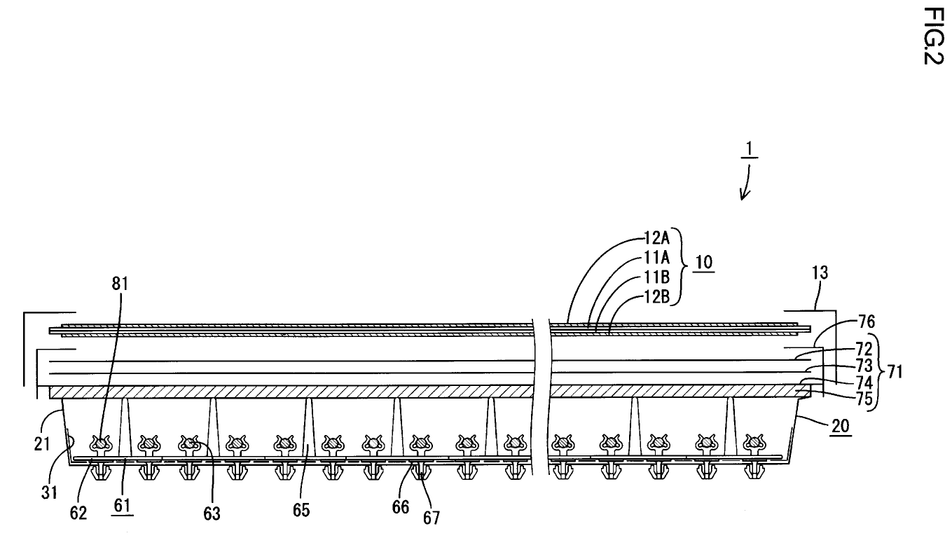

FIG. 1 is an exploded perspective view of a liquid crystal display 1 (corresponding to a displaying apparatus of the present invention) according to a preferred embodiment of the present invention and FIG. 2 is a side cross sectional view of the liquid crystal display 1. The liquid crystal display 1 preferably includes a liquid crystal panel 10 (corresponding to a display panel of the present invention) and a backlight unit 20 (corresponding to an illuminating apparatus for a displaying apparatus of the present invention) which is mounted to the liquid crystal panel 10 from a back surface side thereof, wherein they are held together by a bezel 13. In the following description, a display surface side (the upper side in FIG. 1) of the liquid crystal panel is referred to as a front surface side and the opposite side (the lower side in FIG. 1) is referred to as a back surface side.

Although not shown in detail, the liquid crystal panel 10 has a known configuration wherein a pair of glass substrates 11A, 11B, each having a substantially rectangular plate shape, on which switching elements (for example, TFTs) and pixel electrodes for forming pixels and the like are provided in a matrix, are bonded to each other with a predetermined gap spaced therebetween, and liquid crystal is filled between both glass substrates 11A, 11B. On outer surfaces (surfaces opposite to the liquid crystal layer) of both glass substrates 11A, 11B, polarizing plates 12A, 12B are stacked and preferably have almost the same size as the glass substrates 11A, 11B, respectively.

The backlight unit 20 attached on the back surface side of the liquid crystal panel 10 is located just under the liquid crystal panel 10 so that light sources are positioned on the back surface of the liquid crystal panel 10. The backlight unit 20 includes a backlight case 21 made of metal (corresponding to a case part of the present invention and shortly referred to as a “case 21” hereinafter), a plurality of cold cathode tubes 81 (corresponding to light sources of the present invention) which are received in the case 21, and an optical member 71 mounted in an opening part of the case 21.

The case 21 includes a bottom plate part 22 preferably having a substantially rectangular plate shape which is formed to have almost the same size as the liquid crystal panel 10 and side wall parts 23 respectively standing upright from four sides of the bottom plate part 22 toward the front surface side. Thus, as a whole, the case 21 is formed in a shallow dish-like shape which is open on the front surface side. A large number of fitting grooves 24 into which rubber holders 51 described later can be fitted are provided with an equal pitch in both short sides of the case 21, by cutting out from the upright ends of the short side wall parts 23A to a position nearer the center with respect to the short sides of the bottom plate part 22.

In the case 21, a reflective sheet 31 (corresponding to a reflective member of the present invention) is arranged to reflect light from the cold cathode tubes 81 described later. The reflective sheet 31 is preferably a white sheet formed of plastic and is configured by combining two divided sheets 32, which preferably have substantially the same shape, in a staggered manner. In each divided sheet 32, a bottom plate side sheet piece 32A which matches to the bottom plate part 22 of the case 21 is divided into two parts at a center position in a longitudinal direction of the piece, and side wall side sheet pieces 32B which match to long side wall parts 23 of the case 21 are joined to long side parts of the divided parts, respectively.

On the reflective sheet 31, the cold cathode tubes 81 as light sources are provided. The cold cathode tubes 81 are composed of a plurality of tube bodies which are elongated in the direction of the long sides of the case 21 and are arranged side by side along the direction of the short sides of the case 21. In end parts of the cold cathode tubes 81, electrode parts are provided and wires 82 are guided out from the electrode parts, although not shown in detail.

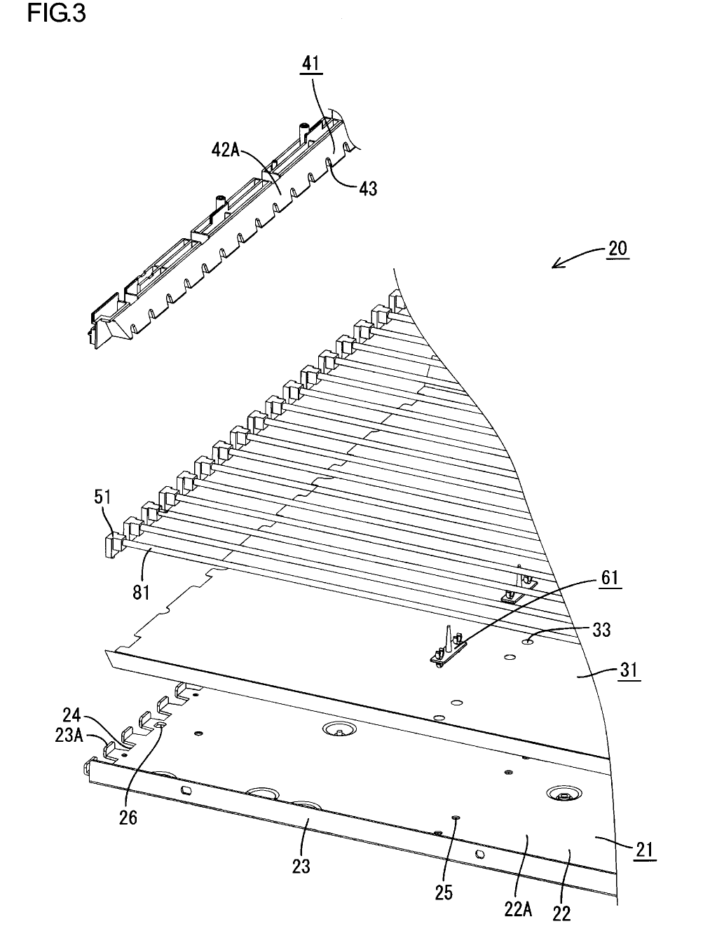

Each cold cathode tube 81 is held at its both end parts by the rubber holders 51 (corresponding to end part light source holding elements of the present invention) which are disposed in both short sides of the case 21. In addition, both end parts are preferably covered by lamp holders 41, together with the rubber holders 51. Further, the cold cathode tube 81 is held by the lamp clips 61 (corresponding to center light source holding elements of the present invention) at a position somewhat nearer the center with respect to both end parts (see FIG. 3).

The lamp holders 41 are preferably formed of white plastic so that they can reflect light from the light sources and a pair of the lamp holders 41 are provided along both short sides of the case 21. Each lamp holder 41 is formed to be elongated along the direction of the short side of the case 21 and has a vessel-like shape which is open on the back surface side (the side facing to the bottom plate part 22 of the case 21). In the lamp holder 41, among a pair of side wall parts 42A, 42B that are arranged substantially parallel to the direction of the short sides of the case 21, an inner side wall part 42A (corresponding to an inclined wall part of the present invention) inclines inwardly as it extends toward the bottom plate part 22. Provision of the inclination is intended to prevent a decrease in luminance in the end part, by improving reflectivity of the emitting light toward the liquid crystal panel 10 in the vicinity of the end parts of the cold cathode tubes 81. Additionally, in the side wall part 42A, slit parts 43 for lamps are provided with an equal pitch, which are open on the side of the bottom wall part 22 and into which the tube bodies of the cold cathode tubes 81 can enter. Further, in an outer side wall part 42B among the pair of the side wall parts 42, slit parts 44 for holders are provided with an equal pitch, which are open on the side of the bottom wall part 22 and can receive the rubber holders 51 described later.

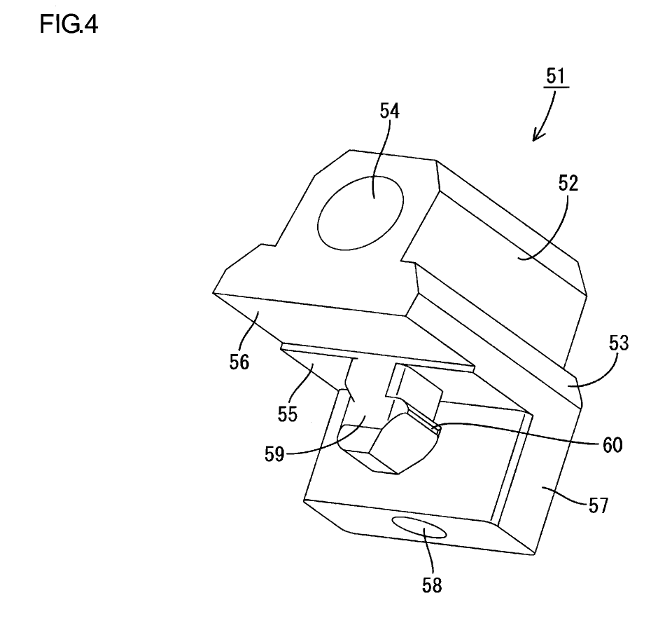

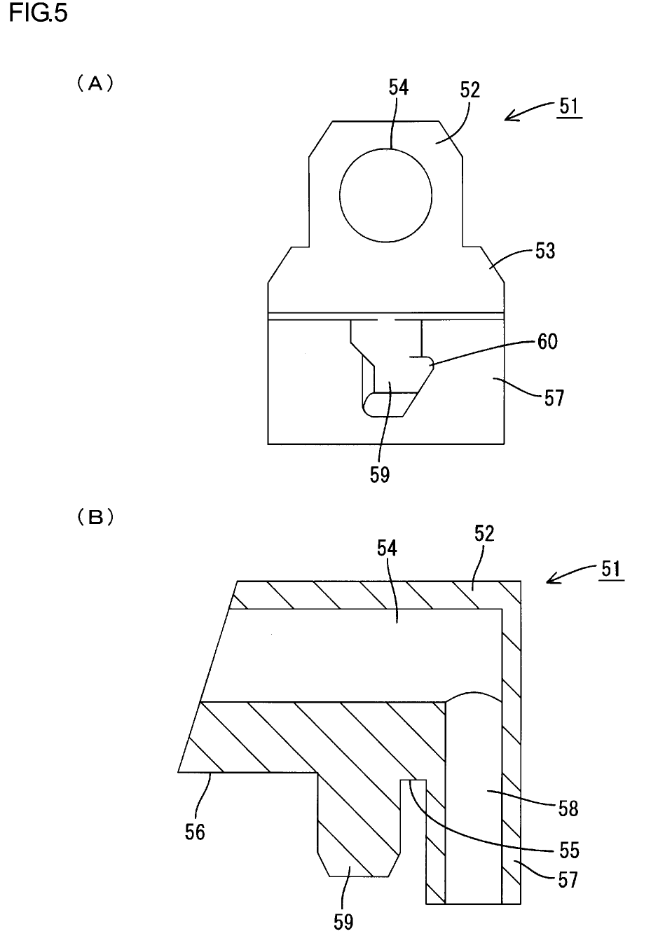

Within the lamp holder 41, the rubber holders 51, which are preferably formed of silicon rubber or the like, are received. The rubber holder 51 includes a tube holding part 52 (corresponding to a light source holding part of the present invention) for holding the end part of the cold cathode tube 81 and a wire guide part 57 which is formed on the back surface side of the tube holding part 52 (see FIGS. 4, 5).

The tube holding part 52 preferably has a block shape as a whole and is provided with a collar part 53 projecting laterally near the back surface (a surface facing the bottom plate part 22) of the tube holding part 52. In the tube holding part 52, a light source receiving hole 54 is provided which has an opening formed in a surface facing inward when the tube holding part 52 is attached to the case 21, so that the electrode part of the cold cathode tube 81 can be inserted into the hole 54.

The outer almost half region in the back surface of the tube holding part 52 is preferably slightly thicker toward the back surface side than the inner region with a step. The height of the step part is slightly larger than the thickness of the reflective sheet 31. The outer thicker part serves as a base part 55 (corresponding to a close fixing part) which is closely fixed to the bottom plate part 22 of the case 21, while the inner thinner part serves as a sheet cover part 56 (corresponding to a cover part of the present invention) which projects above the reflective sheet 31, with a slight spacing from the reflective sheet 31. The projecting end of the sheet cover part 56 extends to reach the inner side wall part 42A of the lamp holder 41 and an end surface of the projecting end is an inclined surface which inclines in a manner corresponding to the inclination of the side wall part 42A.

Further, near the outer end in the back surface of the tube holding part 52, a wire guide part 57 having a thick plate shape is provided which projects toward the back surface side. In the wire guide part 57, a wire receiving hole 58 is provided which is opened on the back surface side. The wire receiving hole 58 and the light source receiving hole 54 of the tube holding part 52 merge to each other at the inside of the tube holding part 52, so that the wire 82 connected to the electrode part of the cold cathode tube 81 inserted in the light source receiving hole 54 is guided out from the wire receiving hole 58 to the back surface side.

Further, on the back surface of the base part 55, a clamping part 59 is provided for clamping the rubber holder 51 to the case 21. The clamping part 59 preferably has a prism-like shape and projects toward the back surface side. In addition, on the side surface of the clamping part 59, a laterally projecting step part 60 is provided at a position nearer the back surface with respect to the base end part by an amount equal to the thickness of the bottom plate part 22 of the case 21.

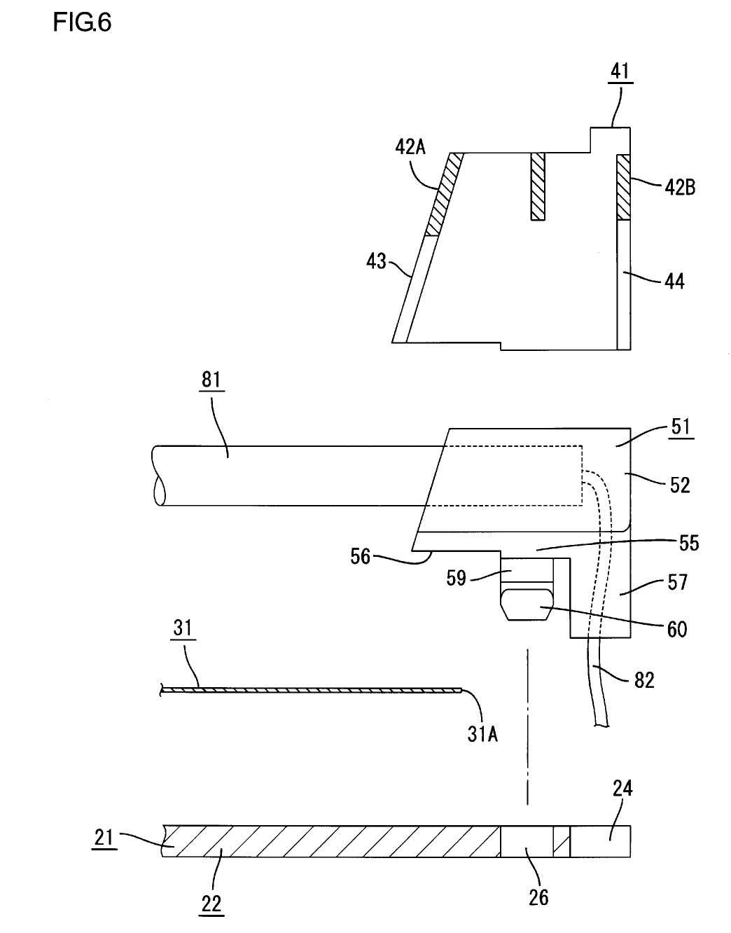

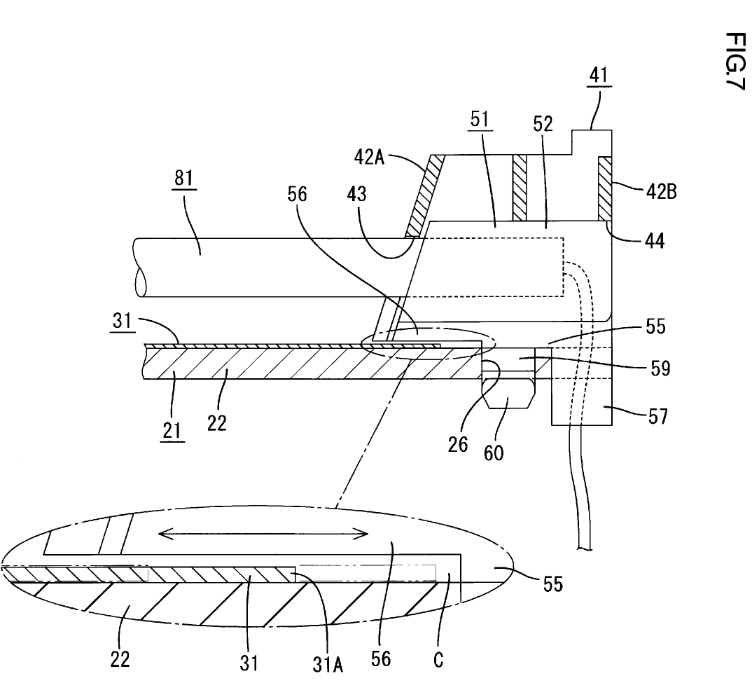

The rubber holder 51 is positioned so that the back surface of the base part 55 closely contacts the bottom plate part 22 of the case 21 and the inner side surface of the wire guide part 57 reaches the inside end of the fitting groove 24 in the bottom plate part 22 (see FIGS. 6, 7). The clamping part 59 is inserted into the clamping hole 26 which is provided through the case 21 at the corresponding position and the step part 60 is locked to the back surface of the hole edge of the clamping hole 26, so that the rubber holder 51 is locked to the bottom plate part 22. In this condition, the reflective sheet 31 enters into a gap between the sheet cover part 56 and the bottom plate part 22 and the end edge 31A of the reflective sheet 31 is located at a slightly inner position with respect to the step part of the base part 55 and the sheet cover part 56. Thus, a predetermined clearance C is provided between the end edge 31A of the reflective sheet 31 and the base part 55 so as to allow expansion/contraction of the reflective sheet 31 in a sheet surface direction due to heat. The clearance C is preferably equal to or larger than the maximum expansion length of the reflective sheet 31 when the temperature in the backlight unit 20 is maximum (about 80° C.) in normal use of the liquid crystal display 1. Specifically, it is believed that the clearance is preferably on the order of about 2 mm, for example, although it depends on the size of the reflective sheet 31. Further, the projecting length of the sheet cover part 56 preferably has a length such that the end edge 31A of the contracted reflective sheet 31 is not disengaged from the sheet cover part 56 when the temperature in the backlight unit 20 decreases with a decrease in the temperature or the like.

The lamp clip 61 is attached on the inner wall surface 22A (corresponding to a wall surface of the present invention) of the bottom plate part 22 of the case 21 and holds the cold cathode tube 81 at a position nearer the center with respect to both end parts of the cold cathode tube 81. Each lamp clip 61 can hold a set of the cold cathode tubes 81 in two rows. Two lamp clips 61 are provided for each set (two rows) of the cold cathode tubes 81 and the lamp clips 61 which support adjacent sets of the cold cathode tubes 81 are arranged in a staggered manner.

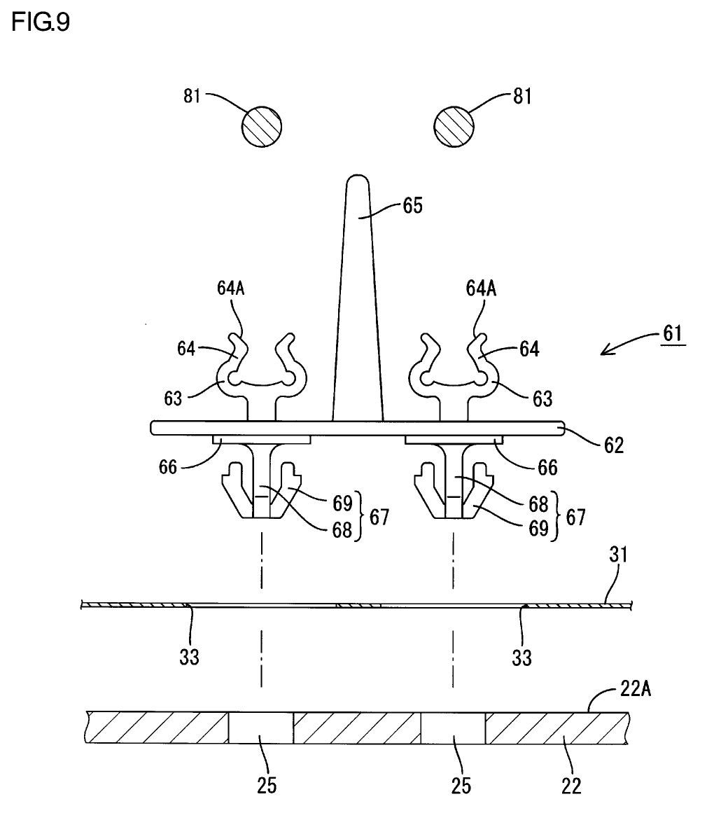

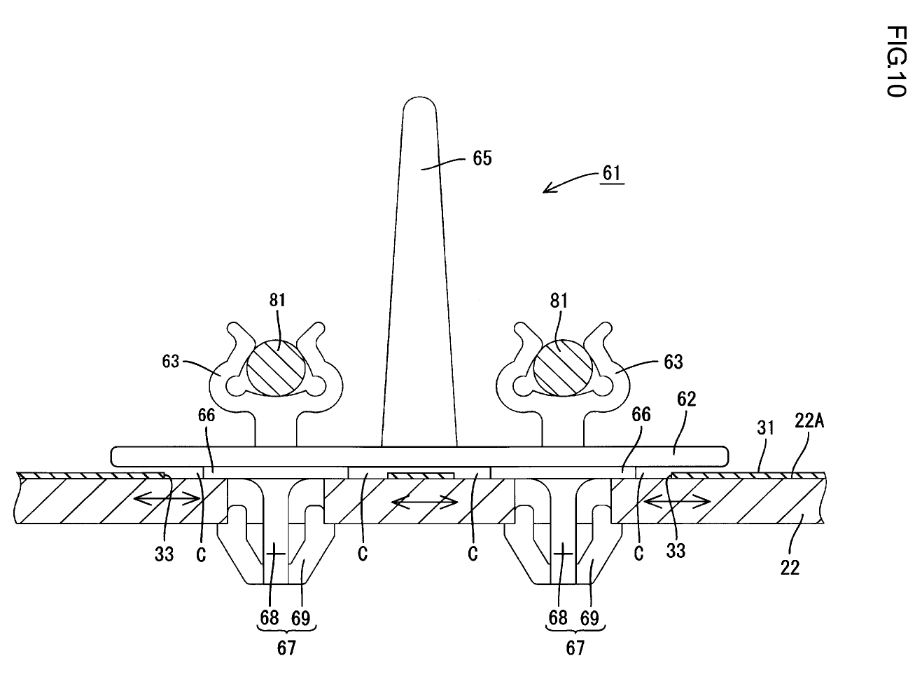

The lamp clip 61 includes a body part 62 (corresponding to a cover part of the present invention) having an elongated substantially rectangular plate shape along the direction of the short side of the bottom plate part 22 (a direction that is substantially perpendicular to the longitudinal direction of the cold cathode tubes 81). On the front surface side (a side opposite to the side facing to the bottom plate part 22) of the body part 62, two clip parts 63 for holding the cold cathode tubes 81 are arranged side by side along the longitudinal direction of the body part 62 (see FIGS. 9, 10). The clip part 63 includes a pair of annular pieces 64 which can spread away from each other along the longitudinal direction of the body part 62. Thus, the clip part 63 has a C-shaped ring configuration which partially opens in its circumferential direction, as a whole. At tip parts of the pair of the annular pieces 64, guide parts 64A are arranged to be bent away from each other and guide the cold cathode tube 81 to be mounted to the clip part 63. When the cold cathode tube 81 is pushed from an opening part of the annular pieces 64, both annular pieces 64 are deformed to spread out and allow passage of the cold cathode tube 81. After the cold cathode tube 81 enters the inside, both annular pieces 64 elastically recover so that they elastically contact the outer circumference of the cold cathode tube 81 to hold it.

In addition, between two clip parts 63, a cone-shaped pin 65 is provided which is tapered toward its tip. The pin 65 is provided to extend close to the opening of the case 21 so that the pin supports the optical member 71 described later from the back surface side.

Additionally, on the back surface side of the body part 62 (the side facing to the bottom plate part 22 of the case 21), a pair of supporting base parts 66 (corresponding to close fixing parts of the present invention) are provided. The supporting base parts 66 preferably have a thin disk shape and are provided at positions corresponding to the back sides of the pair of the clip parts 63, respectively. The thickness of the supporting base parts 66 is preferably slightly larger than the thickness of the reflective sheet 31.

Further, on the back surface side of the supporting base parts 66, locking parts 67 for fixing the lamp clip 61 to the bottom plate part 22 are respectively provided. The locking part 67 includes a base part 68 arranged to extend substantially perpendicularly from the supporting base part 66 toward the back surface side and a pair of elastic locking pieces 69 which extend obliquely upward from a tip part of the base part 68, i.e. extend toward the supporting base part 66 while extending away from the base part 68. Both elastic locking pieces 69 are arranged in a cantilever manner such that they are connected to both side surfaces of the tip part of the base part 68. Thus, the elastic locking pieces 69 can be elastically deformed with the connecting part as a supporting point, along the direction in which they go toward/away from the base part 68.

On the other hand, in the bottom plate part 22 of the case 21, a pair of inserting holes 25 are respectively provided at positions corresponding to the locking parts 67 in the mounting positions of each lamp clip 61. Each inserting hole 25 is formed to have a slightly smaller size than the supporting base part 66 of the lamp clip 61, so as to allow passage of the locking part 67, but not to allow passage of the supporting base part 66. In addition, in the reflective sheet 31 disposed on the bottom plate part 22, a pair of mounting holes 33 are respectively provided at the mounting positions of each lamp clip 61. The mounting hole 33 preferably has a slightly larger size than the supporting base part 66, so as to allow passage of both the locking part 67 and the supporting base part 66. The lamp clip 61 is attached to the bottom plate part 22 via the reflective sheet 31 and closely contacts the bottom plate part 22 so that the supporting base part 66 closes the inserting hole 25. The locking part 67 is inserted in the inserting hole 25 and step parts formed at tip parts of the elastic locking pieces 69 are locked to the circumferential edge in the back side of the inserting hole 25, so that the lamp clip 61 is locked to the bottom plate part 22. Here, the body part 62 of the lamp clip 61 is located above the bottom plate part 22 by an amount that is substantially equal to the thickness of the supporting base part 66 and the body part 62 extends above the surrounding region of the mounting hole 33 in the reflective sheet 31. In addition, the predetermined clearance C is provided between the hole edge 33A of the mounting hole 33 and the supporting base part 66 so as to allow expansion/contraction of the reflective sheet 31 in the sheet surface direction due to heat.

In the opening part of the case 21, the optical member 71 is attached and covers the opening part. The optical member 71 serves to diffuse light from the cold cathode tubes 81 as line light sources into planar uniform light and then emit the light toward the liquid crystal panel 10. The optical member 71 is configured by laminating a diffusing sheet 72, a lens sheet 73, an optical sheet 74, and a diffusing plate 75 in this order from the front surface side. The sheets 72, 73, 74, 75 preferably have a substantially rectangular shape with almost the same size as the liquid crystal panel 10 and are supported by the pins 65 of the lamp clip 61 from the back surface side. In addition, on the front surface side and the back surface side of the optical member 71, frames 76 for mounting the optical member 71 are respectively provided.

Further, on the back surface of the case 21, an inverter unit 91 and an external circuit unit 92 are mounted for controlling lighting of the cold cathode tubes 81, for example.

Then, actions and effects of this preferred embodiment configured in the above described manner will be described.

In assembly of the liquid crystal display 1, the reflective sheet 31 is disposed on the bottom plate part 22 of the case 21 and the locking parts 67 of the lamp clip 61 are inserted in the inserting holes 25 via the reflective sheet 31, so that the lamp clip 61 is fixed to the bottom plate part 22. Then, the cold cathode tubes 81 with the rubber holders 51 attached on the ends thereof are arranged side by side in the case 21 and the tube bodies of the cold cathode tubes 81 are fitted in the clip parts 63 of the lamp clips 61. Additionally, the rubber holders 51 are fitted in the fitting groove 24 of the case 21 and fixed by engaging the clamping part 59 to the clamping hole 26.

Certain errors of dimensions of the entire assembly or positioning of the mounting holes 33 may occur due to mold tolerance of a mold in manufacturing the reflective sheet 31 or the like. However, the clearance C is provided between the end edge 31A of the reflective sheet 31 and the base part 55 of the rubber holder 51 which is located on the outer side of the reflective sheet 31 and closely fixed to the bottom plate part 22, so as to allow a certain degree of dimension errors (see FIG. 7). In addition, the mounting hole 33 is preferably larger than the supporting base part 66 of the lamp clip 61 which closely contacts the bottom plate part 22. Thus, around the mounting hole 33, the predetermined clearance C is set between the hole edge 33A of the mounting hole 33 and the supporting base part 66 so as to allow a certain degree of misalignment (see FIG. 10). Thereby, deflection and wrinkling of the reflective sheet 31 can be prevented.

After the cold cathode tubes 81 are attached, the tube bodies of the cold cathode tubes 81 and the tube holding parts 52 of the rubber holders 51 are received in the slit parts 43 for lamps and the slit parts 44 for holders, respectively, and then the lamp holder 41 is fitted to the case 21. Additionally, the optical member 71, the frame 76, the inverter unit 91, and the external circuit unit 92 are mounted on the case 21 to finish assembly of the backlight unit 20. Finally, the backlight unit 20 is mounted to the liquid crystal panel 10 from the back surface side thereof and fixed by the bezel 13, to finish the liquid crystal display 1.

In the use of this liquid crystal display 1, light emitting from the cold cathode tubes 81 provided on the backlight unit 20 enters into the optical member 71 directly or after being reflected by the reflective sheet 31 on the back surface side. Then, the light which is diffused by the optical member 71 is irradiated to the liquid crystal panel 10 from the back surface side, so that display on the liquid crystal panel 10 is visible.

During the use, due to heat generation of the cold cathode tubes 81, the temperature in the case 21 gradually increases, which leads to thermal expansion of the reflective sheet 31 and the case 21. Because the thermal expansion coefficient of the reflective sheet 31 made of resin is larger than that of the case 21 made of metal, the reflective sheet 31 deforms to expand more significantly than the case 21. On the other hand, during cold periods such as winter, the reflective sheet 31 and the case 21 contract with decreases in the environmental temperature. Also in this case, the reflective sheet 31 deforms to contract more significantly than the case 21 due to the difference of the thermal expansion coefficients. Thus, the case 21 can not follow deformation of the reflective sheet 31, which can result in deflection and wrinkling of the reflective sheet 31 or the like.

However, as described above, the clearance C is provided between the end edge 31A of the reflective sheet 31 and the base part 55 of the rubber holder 51 (see FIG. 7), and also the clearance C is provided between the hole edge 33A of the mounting hole 33 and the supporting base part 66 of the lamp clip 61, around the mounting hole 33 (see FIG. 10). Therefore, expansion/contraction deformation of the reflective sheet 31 in the sheet surface direction can be absorbed by the clearance C, so that deflection and wrinkling of the reflective sheet 31 can be prevented.

Additionally, by inclining the inner side surface of the sheet cover part 56 of the rubber holder 51 along inclination of the side wall part 42A of the lamp holder 41, the sheet cover part 56 can extend close to the side wall part 42A. In other words, by inclining the projecting end surface of the sheet cover part 56, the tip part on the back surface side (the reflective sheet 31 side) of the sheet cover part 56 can be extended close to the wall surface of the lamp holder 41. Thereby, the sheet cover part 56 projecting above the reflective sheet 31 can be formed without making the lamp holder 41 large (i.e. without reducing the effective area of the light emitting surface). Further, because the projecting length of the sheet cover part 56 can be set to be large, curling of the end edge 31A of the reflective sheet 31 away from the sheet cover part 56 can be reliably prevented when the reflective sheet 31 deforms to contract.

Thus, according to this preferred embodiment, the clearance C is provided between the end edge 31A of the reflective sheet 31 and the base part 55 of the rubber holder 51 which is located on the outer edge of the reflective sheet and closely fixed to the bottom plate part 22. In addition, the predetermined clearance C is set between the hole edge 33A of the mounting hole 33 and the supporting base part 66 of the lamp clip 61, around the mounting hole 33. Therefore, expansion deformation of the reflective sheet 31 in the sheet surface direction due to thermal expansion and variation of dimensions due to mold tolerance can be absorbed by the clearances C. As a result, deflection and curling of the reflective sheet 31 can be prevented.

Further, by inclining the inner side surface of the sheet cover part 56 of the rubber holder 51 along the inclination of the side wall part 42A of the lamp holder 41, the sheet cover part 56 can be arranged to extend close to the side wall part 42A. In other words, by inclining the projecting end surface of the sheet cover part 56, the tip part on the back surface side (the reflective sheet 31 side) of the sheet cover part 56 can be extended close to the wall surface of the lamp holder 41. Thereby, the clearance C can be set to be as large as possible which allows expansion of the reflective sheet 31 without reducing the effective area of the light emitting surface, so that curling of the end edge 31A of the reflective sheet 31 away from the sheet cover part 56 can be securely prevented.

The technical range of the present invention is not limited to the above described preferred embodiment, but the following features are within the technical range of the present invention, for example. The technical range of the present invention extends to other equivalent ranges.

Although the close fixing part of the lamp clip is preferably shaped as the disk-like supporting base part 66 provided on the base end part of the locking part 67 in a preferred embodiment of the present invention, any shape is possible as long as the body part can be supported with a spacing from the bottom plate part. For example, a substantially rectangular shape or frame shape can be used. Further, the base part 66 may be provided at a position separate from the locking part 67.

Although the lamp clip in the present preferred embodiment supports a set of the cold cathode tubes arranged in two rows, the configuration of the lamp clip is not limited to this arrangement. The lamp clip may support a set of the cold cathode tubes in one row or three or more rows, for example. In addition, the rubber holder may support a set of the cold cathode tubes in two or more rows.

Although preferred embodiments of the present invention described above are preferably applied to the liquid crystal display 1, the present invention is not limited to liquid crystal displays. The present invention can be applied to any displaying apparatus provided with a backlight apparatus on the back surface side of the display panel.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-13. (canceled)

14. An illuminating apparatus for a displaying apparatus comprising:
light sources;
a case part arranged to receive the light sources;
a reflective member arranged to reflect light from the light sources, the reflective member being disposed on a wall surface of the case part;
light source holding elements arranged to hold the light sources and the reflective member, the light source holding elements being attached to the wall surface of the case part;
a close fixing part provided in the light source holding elements and closely contacting the wall surface of the case part;
a cover part disposed around the close fixing part extending along the wall surface with a spacing from the wall surface, the cover part projecting above the reflective member; and
light source holding parts arranged to hold the light sources, the light source holding parts being provided in at least one of the close fixing part or the cover part, wherein a clearance is provided between an edge of the reflective member and the close fixing part to allow for misalignment of the reflective member in a surface direction.

15. The illuminating apparatus for a displaying apparatus according to claim 14, wherein the light source holding elements include a center light source holding element arranged to hold the light source at an approximately central position in relation to ends of the light source holding elements.

16. The illuminating apparatus for a displaying apparatus according to claim 15, wherein the reflective member is provided with mounting holes through which the close fixing parts of the light source holding elements can be inserted.

17. The illuminating apparatus for a displaying apparatus according to claim 16, wherein a clearance is provided between a hole edge of the mounting hole and the close fixing part.

18. The illuminating apparatus for a displaying apparatus according to claim 14, wherein the light source holding elements include an end part light source holding element arranged to hold the light source at both ends of the light source, and the close fixing part is fixed at an outer position in the case part with respect to an end edge of the reflective member.

19. The illuminating apparatus for a displaying apparatus according to claim 18, wherein the cover part is arranged to extend from the close fixing part toward the center of the reflective member, and a clearance is provided between the end edge of the reflective member and the close fixing part.

20. The illuminating apparatus for a displaying apparatus according to claim 14, wherein the light source holding elements include an end part light source holding element arranged to hold the light source at ends of the light source, and the close fixing part is fixed at an outer position in the case part with respect to an end edge of the reflective member, and the cover part is arranged to extend from the close fixing part toward the center of the reflective member, and a clearance is provided between the end edge of the reflective member and the close fixing part.

21. The illuminating apparatus for a displaying apparatus according to claim 20, wherein the case part is provided with an inclined wall part located at an end of the light sources and descends toward an inner direction of the case part and reflects light from the light source, and the end part light source holding element is provided on an outer side of the inclined wall part.

22. The illuminating apparatus for a displaying apparatus according to claim 21, wherein a surface of the cover part facing toward the inner direction of the case part is an inclined surface extending along the inclined wall part.

23. The illuminating apparatus for a displaying apparatus according to claim 14, wherein the light source holding element is formed of a polymer material.

24. The illuminating apparatus for a displaying apparatus according to claim 14, wherein the light source holding element is white.

25. The illuminating apparatus for a displaying apparatus according to claim 14, wherein the light source holding element is opalescent.

26. The illuminating apparatus for a displaying apparatus according to claim 14, wherein the light source holding element is transparent.

27. A displaying apparatus comprising:
a display panel; and
an illuminating apparatus arranged to illuminate the display panel, the illuminating apparatus being provided on a back surface of the display panel, wherein the illuminating apparatus includes light sources, a case part arranged to receive the light sources, a reflective member arranged to reflect light from the light sources, the reflective member being disposed on a wall surface of the case part, light source holding elements arranged to hold the light sources and the reflective member, the light source holding elements being attached to the wall surface of the case part, a close fixing part provided in the light source holding element and arranged to closely contact the wall surface of the case part, a cover part disposed around the close fixing part and extending along the wall surface with a spacing from the wall surface, the cover part projecting above the reflective member, and light source holding parts arranged to hold the light sources, the light source holding parts being provided in the close fixing part or the cover part, and a clearance is provided between an edge of the reflective member and the close fixing part to allow for misalignment of the reflective member in a surface direction.

28. The displaying apparatus according to claim 27, wherein the display panel is configured so that polarization of an electromagnetic wave is electrically controlled.

29. The displaying apparatus according to claim 27, wherein the display panel is configured so that strength of an electromagnetic wave is controlled by a physical or mechanical shuttering scheme.

30. The displaying apparatus according to claim 27, wherein the display panel is a liquid crystal panel and the displaying apparatus is a liquid crystal display.

31. A displaying apparatus comprising the illuminating apparatus for a displaying apparatus according to claim 14, an optical member, and a passive display panel having no self-luminous elements.
